(19) United States
(12) Patent Application Publication
(10) Pub. No.: US 2020/0329647 A1
(43) Pub. Date: Oct. 22, 2020

(54) SOLAR POWER GENERATION PLANT INSTALLABLE ON AGRICULTURAL INSTALLATIONS

(71) Applicant: REM TEC S.R.L., Asola (IT)

(72) Inventors: Ronald KNOCHE, Garches (FR); Giancarlo GHIDESI, Asola (IT)

(21) Appl. No.: 16/643,067

(22) PCT Filed: Sep. 10, 2018
(86) PCT No.: PCT/IB2018/056881

§ 371 Date: Feb. 28, 2020

(30) Foreign Application Priority Data
Sep. 11, 2017 (IT) 102017000101151

(51) Int. Cl. A01G 9/24; F24S 25/12; F24S 30/455; F24S 50/00; H02S 20/22; H02S 20/30; A01G 9/14

(52) U.S. Cl. CPC A01G 9/243; F24S 25/12; F24S 30/455; F24S 50/00; H02S 20/22; H02S 20/30; F24S 2025/017; A01G 9/241; A01G 9/249; A01G 9/24; A01G 9/247; A01G 9/14; A01G 9/246

(57) ABSTRACT

A power generation plant includes a support structure formed by supporting piles aligned fastened to the ground, such structure being a bi-dimensional structure placed on an agricultural land, with any orientation. The power generation plant further includes a handling system for solar energy receptor devices placed on the piles arranged in a row, adapted to allow the handling of such devices around at least a first axis. The plant also includes one or more greenhouses for intensive cultivation of agricultural products, on the ground beneath such receptor devices, between rows of adjacent piles.

### TECHNICAL FIELD

The present disclosure relates to a solar power generation plant formed by a support structure constrained to the ground, preferably an agricultural land, adapted to support a handling system for devices adapted to receive sunlight, for example photovoltaic panels. In particular, the handling system of the present disclosure allows the handling preferably around two axes X and Y of such devices to allow them to keep photovoltaic panels or other devices adapted to capture the solar energy properly orientated towards the sun.

Such plant is installable on agricultural lands, leaving the possibility of taking advantage of such land for the original purposes, that is for the cultivation of vegetables or animal grazing.

### BACKGROUND

Handling systems of solar panels on two axes are known, which in jargon are called “sun trackers”.

The main object of a tracker is the one of maximizing the efficiency of the device accommodated on board. The modules mounted on board a tracker in the photovoltaic field generally are arranged geometrically on a single panel, a practice that avoids the use of a tracker for each individual module. The greater the perpendicular alignment with the solar rays, the greater the conversion efficiency and the energy generated, surface being equal; the smaller the surface of the solar panel required, the lower the plant costs, required production being equal.

The more sophisticated trackers have two levels of freedom with which they set out to perfectly align the orthogonal of the photovoltaic panels with the sun rays in real time. The most affordable—but not only—method for making them is mounting a tracker on board another one. These trackers register increases in electric production that also reach 35%-45%, however against a greater construction complexity.

Such type of sun tracker is shown in Patent Application WO2010103378, which describes a load-bearing structure formed by supporting piles kept in position by a grid of tie rods; both the supporting piles and the tie rods are secured in the ground by means of a hinge pin.

The sun tracker comprises a horizontal load-bearing main profile, which may rotate around its own axis, to which there are connected a plurality of secondary profiles, perpendicularly secured to the main profile and which may be rotated around their main axis. The solar panels are secured on such secondary profiles. The ends of the main profile of the tracker are resting and secured on such supporting profiles. Also the electric cables for connecting the various panels and load bearings externally using current generated by them are positioned in the main profile.

Patent WO2013076573 describes a support piling structure of such type that also supports wind modules. Such structure is made bi-dimensional like a “chessboard” and may be installed also on agricultural lands because it is overhead and the distance between the supporting piles is such as to allow the passage of even large agricultural means.

Patent Application WO2013117722 describes a method and a solar power generation plant suitable for being installed on an agricultural land. The photovoltaic modules and the support structure in such plant may be oriented so that a cultivated area, which is beneath the modules, is partially shaded. In this case, the orientation of the photovoltaic modules according to the disclosure allows the incident solar radiation on the cultivated plants.

### SUMMARY

Such support structures for the solar panels not only leave a suitable space for cultivating vegetables, but such space may be used for installing agricultural structures for intensive cultivation, such as for example greenhouses. Moreover, a portion of the power generated by the plant may be used for controlling and feeding the apparatuses in the greenhouse itself.

One aspect of the present disclosure relates to a solar power generation plant having the features of claim 1.

Further features of the present disclosure are contained in the dependent claims.

### BRIEF DESCRIPTION OF THE DRAWINGS

The features and advantages of the present disclosure will be more apparent from the following description of an embodiment of the disclosure, which is to be understood as exemplifying and not limiting, with reference to the attached schematic drawings, wherein:

FIG. 1 illustrates a perspective view of a plant according to the present disclosure;

FIG. 2 illustrates a front view of the plant of FIG. 1;

FIG. 3 illustrates a top view of the plant of FIG. 1;

FIG. 4 illustrates a block diagram of the control of the plant performed by the electronic control unit,

FIG. 5 illustrates a block diagram of the software for calculating the shading generated by the photovoltaic modules of the system,

FIG. 6 illustrates a block diagram of the software for calculating the climatic conditions of the greenhouse as a function of the shading generated by the receptor devices, of the outdoor environmental conditions, of the features of the greenhouse and of the apparatuses inside the greenhouse itself.

FIG. 7 illustrates a block diagram of the software that manages the interaction between the different apparatuses, including the receptor devices, in order to optimize the conditions inside the greenhouse with respect to the need of so the crop and the greenhouse energy balance.

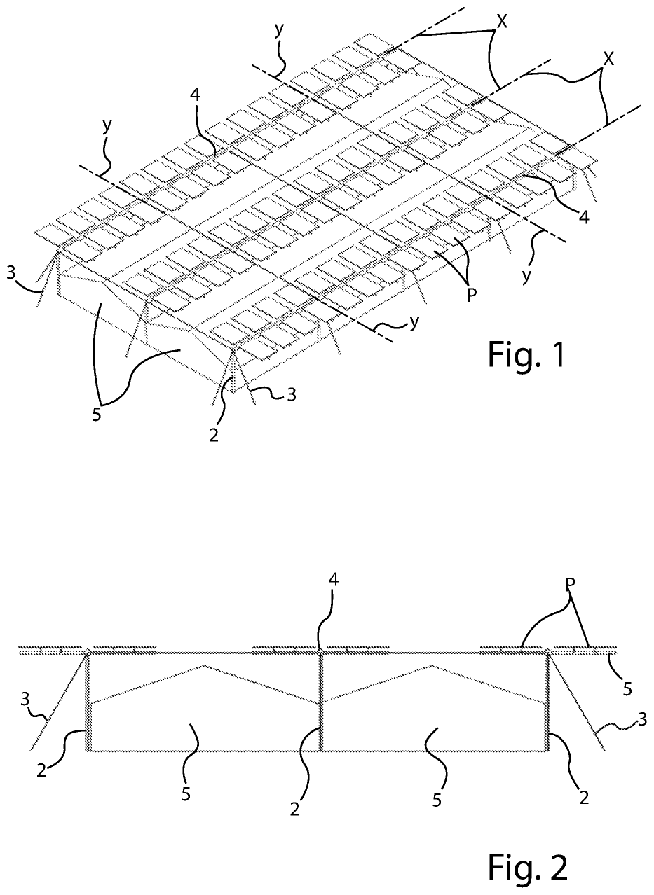

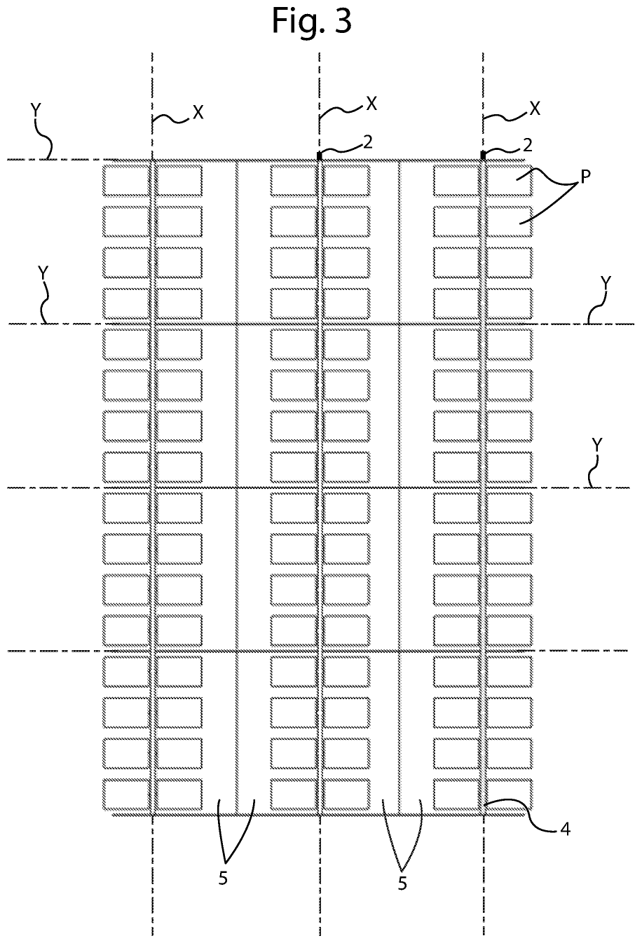

### DETAILED DESCRIPTION OF THE DRAWINGS

With reference to the mentioned figures, the solar power generation plant according to the present disclosure allows the handling on a first axis X and a second axis Y substantially orthogonal to each other, of devices adapted to receive sunlight, in order to allow them to keep a correct orientation towards the sun. For example, such devices are photovoltaic panels or other devices adapted to capture solar energy.

The plant essentially comprises a support structure formed by supporting piles 2 preferably kept in position by a grid of tie rods or steel bars 3; both the supporting piles and the tie bars are secured in the ground by means of suitable pins, for example hinge pins. Such structure advantageously may be configured bi-dimensional, for example like a “chessboard”, and may be installed on agricultural lands, with any orientation, because it is overhead and the distance between the supporting piles is such as to allow the passage of even large agricultural means.

Such support structure alternatively may be made by means of piling made of concrete piles, which will have one portion fastened into the ground and a part out of the ground adapted to give the structure the adequate height off the ground. Said piling may or may not be connected by tie rods or steel bars.

Systems for handling or orientating such solar devices are placed on said support structure and in particular on rows of piles.

Each handling system comprises a main rotating profile 4 that rotates around its own axis, and arranged to operate substantially horizontally, to which there are connected a plurality of secondary profiles 5, preferably secured perpendicularly to the main profile in a rigid manner or alternatively by means of suitable systems adapted to give it the capability to rotate. The receptor devices are fastened on such secondary profiles, in the specific case illustrated, the photovoltaic panels P.

The handling system further comprises a handling mechanism for the primary profiles and as an option, also a handling mechanism for the secondary profiles.

Clearly, the materials for the various components were adequately selected for a proper balancing between weights and sturdiness.

The movements of the motors that allow the aforesaid rotations around the axes X and Y are controlled by a specific electronic processing unit that determines the angle that the panels are to have throughout the day and in all climatic conditions, with feedback by means of specific inclination sensor.

According to the present disclosure, one or more greenhouses S, arranged between two or more adjacent rows of piles, may be placed on the ground on which the plant is mounted. In the illustrated embodiment, the greenhouses have a dome roof, but greenhouses of any shape and sizes such as to occupy the free space beneath the support structure may alternatively be placed.

The greenhouses may be placed only in a portion of the land or they may completely occupy the ground beneath the plant.

Each greenhouse has therein adequate automatic equipment for intensive cultivation, such as for example air conditioning devices inside the greenhouse, humidifier/dehumidifier devices, shading devices for greenhouse glasses, artificial lighting devices, ventilation devices, rainwater recovery, motorized windows, mobile thermal screens, irrigation devices, and electric power storage devices and heat storage devices.

Advantageously according to the present disclosure, the electronic processing unit controlling the movement of the receptor devices—such as photovoltaic panels—of the power generating plant may control such equipment to regulate the conditions inside the greenhouse according to the type of crop implanted and optimize the greenhouse energy balance.

For this purpose, in the plant there is a plurality of devices for monitoring the environmental conditions, such as for example sensors of the temperature inside/outside the greenhouse, sensors of the humidity inside/outside the greenhouse, soil humidity sensors, luminosity sensors, solar radiation sensors, atmospheric pressure sensors, sensors for checking the dew point, CO₂ concentration sensors, wind speed and direction gauges and rain sensors, gauges of the air velocity inside the greenhouse. Based on the measurements of such sensors, the electronic processing unit determines the positioning of the photovoltaic panels moment-by-moment and determines the activation of the aforesaid equipment.

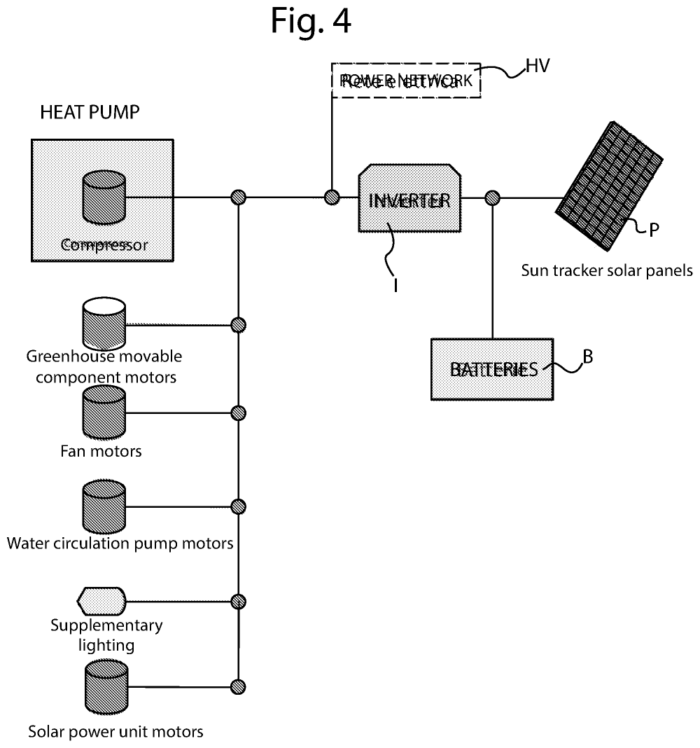

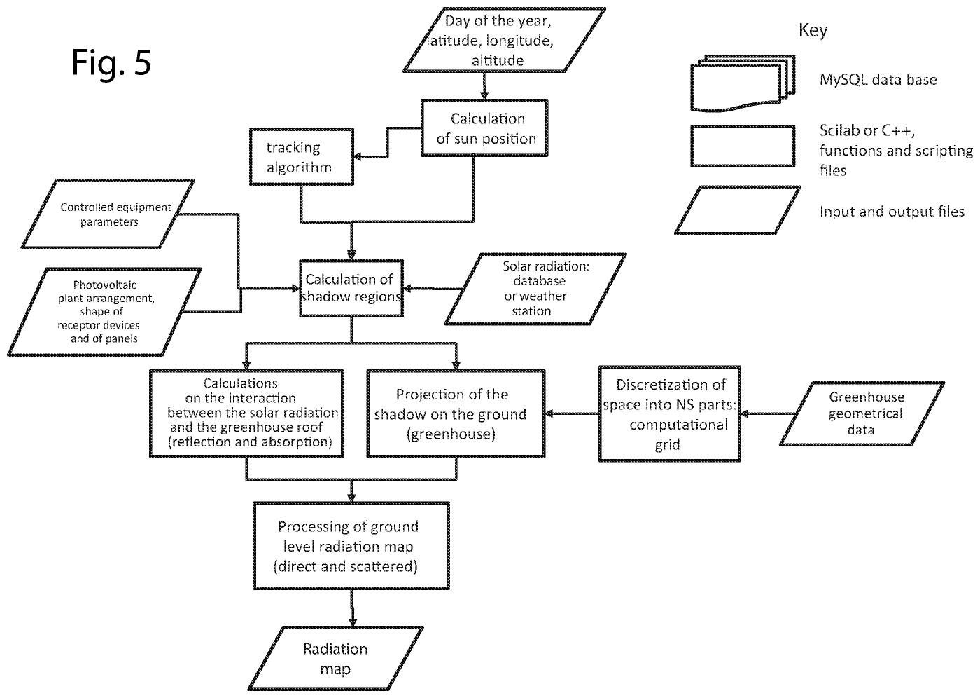

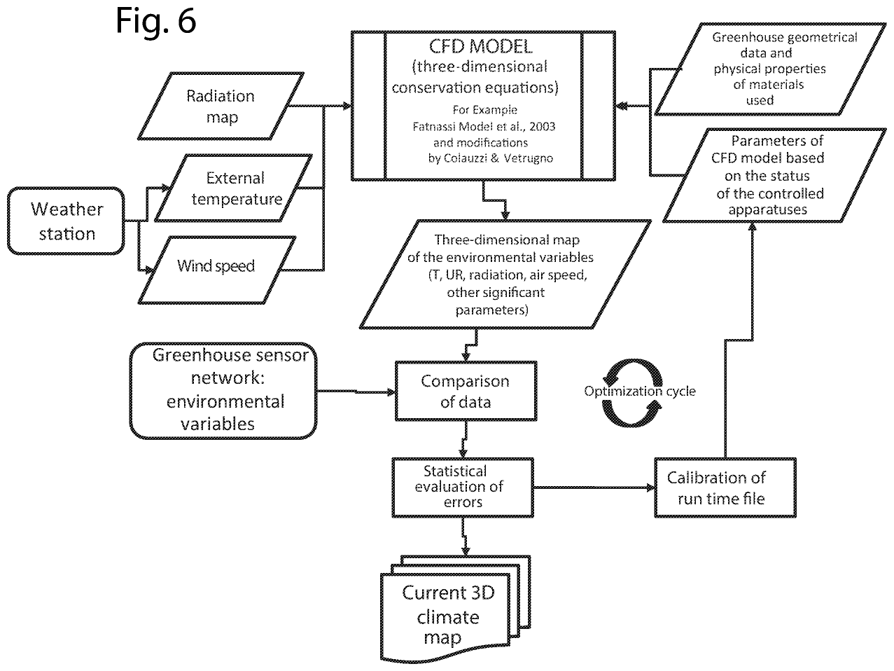

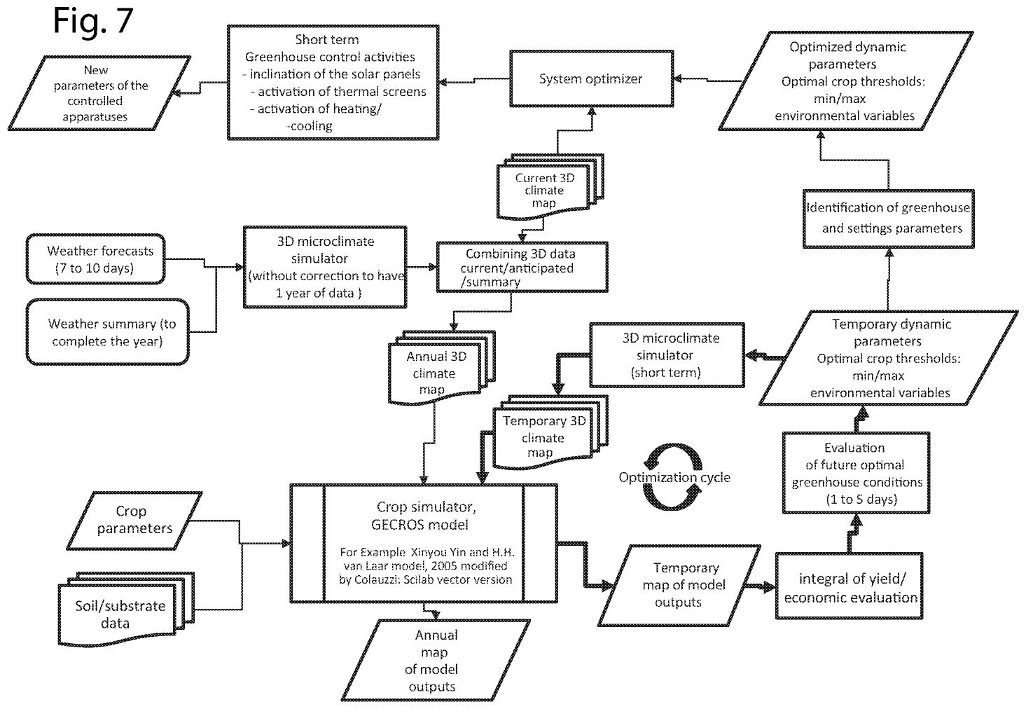

FIG. 4 illustrates a block diagram of how the processing unit operates.

In particular, the electrical power required for the greenhouse equipment is obtained from the solar panels P by means of suitable inverters I, which may or may not be connected to the HV electric network. A system for storing the energy B results in the possibility of locally storing such required energy. The unit in particular controls the motors that move the solar panels (first X and second Y axis), the motors that move the window screen shades, fans, etc., compressors, pumps and any other motorized device of the greenhouse. The unit also controls any possible supplementary lighting devices.

1. A power generation plant comprising:
a support structure formed by a plurality of supporting piles aligned fixed to the ground, said support structure being a bi-dimensional structure placed on an agricultural land, with any orientation,
a handling system configured for a plurality of solar energy receptor devices placed on the plurality of supporting piles arranged in a row, adapted to allow movement of said receptor devices around at least a first axis,
wherein said plant comprises on the ground beneath said receptor devices, between rows of adjacent supporting piles, at least one greenhouse configured for intensive cultivation of agricultural products, and said handling system comprising an electronic processing unit capable of controlling the movement of receptor devices and automatic equipment for intensive greenhouse cultivation using a software configured for calculating the shading of receptor devices, the indoor conditions of the greenhouse according to predetermined parameters, the agricultural yield, and energy production, on the basis of current and anticipated data, and configured for calculating achievement of the best greenhouse energy balance, taking into account agricultural needs,
said plant further comprising a plurality of monitoring devices configured to monitor environmental conditions in said plant outside the greenhouse,
wherein said electronic processing unit is configured to control movement of the receptor devices, control equipment to regulate conditions inside the greenhouse, i.e. depending on the type of crop being implanted, by optimizing the greenhouse energy balance based on such conditions,
said electronic processing unit receiving data from said monitoring devices and controls movement of the receptor devices and equipment in order to regulate conditions inside the greenhouse according to the type of crop being implanted.

2. The plant according to claim 1, wherein said equipment comprises at least one of the following devices: air conditioning devices inside the greenhouse, humidifier/dehumidifier devices, shading devices for greenhouse glasses, artificial lighting devices, ventilation devices, motorized windows, mobile thermal screens, irrigation devices, rainwater recovery, power storage devices,. and heat storage devices.

3. (canceled)

4. (canceled)

5. The plant according to claim 1, wherein said monitoring devices comprise at least one of the following sensors: sensors of temperature inside/outside the greenhouse, sensors of humidity inside/outside the greenhouse, soil humidity sensors, gauges of air velocity inside the greenhouse, luminosity sensors, sensors for checking dew point, CO2 concentration sensors, wind speed and direction gauges and rain sensors, rain sensors, solar radiation, and atmospheric pressure sensors.

6. (canceled)

7. The plant according to claim 1, wherein the receptor devices are photovoltaic panels.

8. The plant according to claim 1, wherein the receptor devices rotate around a second axis, substantially orthogonal to said first axis.

9. The plant according to claim 8, wherein said handling system comprises a rotating main profile around said first axis, to which a plurality of secondary profiles associated with said main profile are connected, the receptor devices being fixed on said secondary profiles.

10. The plant according to claim 1, wherein said electronic processing unit adjusts the various devices achieving a balance between energy production and agricultural production.

11. The plant according to claim 10, wherein system optimization is achieved using the production forecasts of an energy component of the receptor devices and of an agricultural component resulting from weather forecasts and changes in the parameters of the greenhouse.
